(19) United States
(12) Patent Application Publication
(10) Pub. No.: US 2022/0084050 A1
(43) Pub. Date: Mar. 17, 2022

(54) INFORMATION PROCESSING SYSTEM, INFORMATION PROCESSING APPARATUS, AND INFORMATION PROCESSING METHOD

(71) Applicant: TOSHIBA TEC KABUSHIKI KAISHA, Tokyo (JP)

(72) Inventor: Masaki TOUMORI, Yokohama Kanagawa (JP)

(21) Appl. No.: 17/342,479

(22) Filed: Jun. 8, 2021

(30) Foreign Application Priority Data
Sep. 14, 2020 (JP) 2020-153759

(51) Int. Cl. G06Q 30/02; G06K 7/10

(52) U.S. Cl. CPC G06Q 30/0201; G06K 7/10366

(57) ABSTRACT

According to an embodiment, one or more wireless tag readers are connected to an information processing apparatus. The information processing apparatus calculates the number of wireless tags in a store on the basis of the number of pieces of unique information for specifying wireless tags carried by customers staying in the store, the unique information being received by the wireless tag reader. The information processing apparatus determine a crowd density of the store on the basis of the calculated number of the wireless tags, and outputs information regarding the determined crowd density to a display so as to be displayable.

### CROSS-REFERENCE TO RELATED APPLICATIONS

This application is based upon and claims the benefit of priority from the prior Japanese Patent Application No. 2020-153759, filed on Sep. 14, 2020, the entire contents of which are incorporated herein by reference.

### FIELD

An embodiment to be described here generally relates to an information processing system, an information processing apparatus, and an information processing method.

### BACKGROUND

In stores such as supermarkets and mass retailers, the inside of a store (hereinafter, referred to as a “store”) is crowded with customers in accordance with the time zone in some cases. When a store is crowded, a payment section for making a payment for products is crowded and many customers stand in a checkout line. In the case where a customer cannot grasp the crowded situation, the customer may enter the store without knowing the crowded situation (congestion situation). Further, in order to cope with recent infectious diseases, some customers decline to enter the store in the case where the store is crowded, but the customers may think whether to enter the store if the crowded situation of the store cannot be grasped.

### BRIEF DESCRIPTION OF THE DRAWINGS

FIG. 1 is an explanatory diagram showing a situation of a store according to an embodiment;

FIG. 2 is a block diagram showing a hardware configuration of a server according to the embodiment;

FIG. 3 is a memory map showing a crowd monitoring unit according to the embodiment;

FIG. 4 is a memory map showing a part of a crowd master according to the embodiment;

FIG. 5 is a memory map showing another part of the crowd master according to the embodiment;

FIG. 6 is a block diagram showing a hardware configuration of a wireless tag issuing apparatus according to the embodiment;

FIG. 7 is a flowchart showing a part of control processing of the wireless tag issuing apparatus according to the embodiment;

FIG. 8 is a functional block diagram showing a functional configuration of a server according to the embodiment; and

FIG. 9 is a flowchart showing a flow of control processing of the server according to the embodiment.

### DETAILED DESCRIPTION

According to an embodiment, an information processing apparatus manages sales of products in a store in which a wireless tag to which unique information is written is issued to a customer entering the store, the customer carrying the wireless tag to enter the store. The information processing apparatus includes a first communication interface, a second communication interface, a storage device, and a processor. The first communication interface communicates with a wireless tag reader that receives the unique information from the wireless tag carried by the customer in the store. The second communication interface communicates with a display that displays information regarding a crowd density indicating a density of crowd in the store. The storage device holds a master file for storing in advance the crowd density of the store in accordance with the number of customers in the store. The processor acquires, via the first communication interface, the unique information received by the wireless tag reader from the wireless tag carried by the customer. The processor calculates, on the basis of the number of pieces of acquired unique information of the wireless tag, the number of the wireless tags in the store as the number of customers in the store. The processor searches the master file on the basis of the calculated number of customers in the store, and acquires the crowd density from the master file to determine the crowd density of the store. Further, the processor outputs information regarding the crowd density acquired in the determination to the display via the second communication interface so as to be displayable on the display.

An embodiment will be described below with reference to the drawings. The same reference symbols in the drawings will denote the same or similar portions. In the embodiment, a server as a store server used in a store management system installed in a store will be described as an example of an information processing apparatus. Note that the embodiment is not limited by the following description.

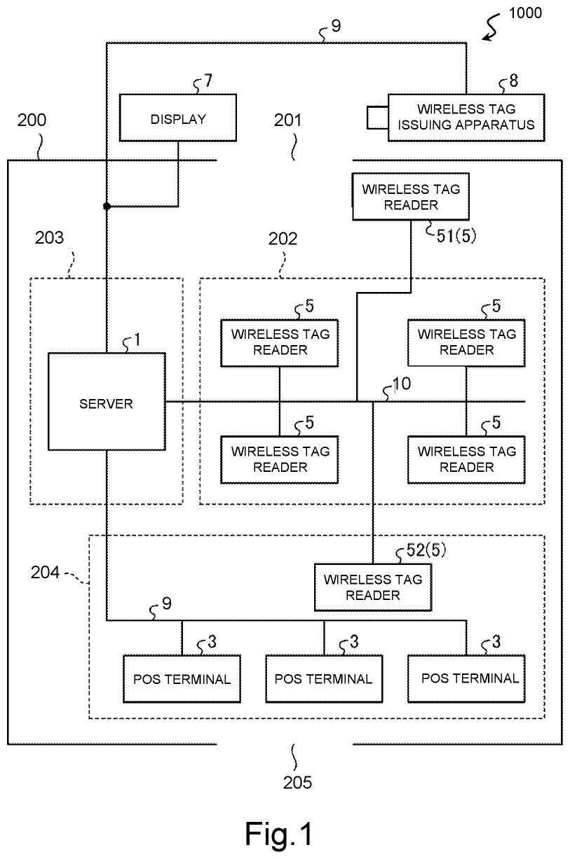

FIG. 1 is an explanatory diagram showing a situation of a store 200 according to the embodiment. The store 200 is, for example, the store 200 that sells products, such as a supermarket and a mass retailer. The store 200 includes an entrance 201, three areas of a shopping area 202, a backyard 203, and a payment area 204 (payment section), and an exit 205. An information processing system 1000 manages the store by processing information of the store. The information processing system 1000 includes a server 1, a POS terminal 3, a wireless tag reader 5, a display 7, and a wireless tag issuing apparatus 8, which will be described below.

In the shopping area 202, shelves and the like on which products are displayed are disposed. A customer shops by moving in the shopping area 202 and putting a product that he/she wants to purchase in a basket or a cart. One or more wireless tag readers 5 are installed in the shopping area 202. The installed wireless tag reader 5 receives tag information transmitted by a wireless tag carried by the customer moving in the shopping area 202. It is desirable that a plurality of wireless tag readers 5 is installed in the shopping area 202.

The wireless tag reader 5 installed in each product area repeatedly receives information of the wireless tag located in the same area, so that it is capable of understanding how long the wireless tag stays in which product area.

In the embodiment, at least one wireless tag reader 5 is installed for each product area in the shopping area 202. The product area is an area where products of the same classification are displayed, such as a vegetable area where products of the classification of vegetables are collected, a fish area where products of the classification of fish are collected, a meat area where products of the classification of meat are collected, and a confectionery area where products of the classification of confectionery are collected. By analyzing the information of the wireless tag, it is possible to understand in which area in the store 200 customers are concentrated in which time zone, the degree of concentration, and the like, and to formulate sales strategies for the products, which leads to sales promotion of the products.

Now, the wireless tag is described. The wireless tag has, as the storage area of information, a company area, a store area, and a unique area. In the company area, a company code for specifying a company that operates the store 200 is stored. In the store area, a store code for specifying the store 200 is stored. In the unique area, a unique number (unique information) for specifying the wireless tag so as to be distinguishable from other wireless tags is stored. The company code, the store code, and the unique number stored in the wireless tag are collectively referred to as the tag information. That is, the tag information includes a company code, a store code, and a unique number.

The wireless tag issuing apparatus 8 that issues a wireless tag is provided in the vicinity of the entrance 201 outside the store 200. The wireless tag issuing apparatus 8 issues a wireless tag to a customer who enters the store from the entrance 201 of the store 200. The wireless tag issuing apparatus 8 generates tag information including a unique number automatically issued for each wireless tag to be issued, and writes the tag information to the wireless tag to be issued. Note that the wireless tag issuing apparatus 8 desirably serves also as a function of a printer for printing numbered ticket-like information on the surface of the wireless tag to be issued. By printing the information, the wireless tag can have a numbered ticket-like function of limiting or permitting customers who enter the store 200.

Further, the wireless tag issuing apparatus 8 has a function of reading a customer card in which a customer code for specifying the customer is stored. The wireless tag issuing apparatus 8 transmits, to the server 1, at least the unique information included in the generated tag information in association with the read customer code.

The wireless tag reader 5 is installed also in the vicinity of the entrance 201 of the store 200 and in the payment area 204. A wireless tag reader 51, which is the wireless tag reader 5 provided in the vicinity of the entrance 201 of the store 200, receives tag information from a wireless tag received from the wireless tag issuing apparatus 8 by a customer entering the store through the entrance 201, the wireless tag being carried by the customer. The wireless tag reader 51 clocks the time at which the tag information was received. The wireless tag reader 51 transmits, to the server 1, the tag information together with the time of clocking. A wireless tag reader 52, which is the wireless tag reader 5, is provided in the payment area 204. In the payment area 204, the wireless tag reader 52 receives tag information from the wireless tag carried by the customer who uses the POS terminal 3 to perform the product registration processing and the payment processing of the product to be purchased. The wireless tag reader 52 clocks the time at which the tag information was received. The wireless tag reader 52 transmits, to the server 1, the tag information together with the time of clocking. Note that the wireless tag reader 5 other than the wireless tag reader and the wireless tag reader 52 also clocks the time at which the tag information was received. The wireless tag reader 5 also transmits, to the server 1, the tag information together with the time of clocking. If the wireless tag reader 51 provided in the vicinity of the entrance 201 of the store 200 is unable to receive the tag information from the wireless tag carried by the customer who enters the store, another wireless tag reader 5 except for the wireless tag reader 52 clocks the time substantially corresponding to the time of entry on behalf of the wireless tag reader 51, and transmits the time of clocking to the server 1.

The server 1, which is a store server, is installed in the backyard 203. The server 1 manages sales of products in the store 200 by receiving the product information and payment information of the product on which payment processing has been performed by the POS terminal 3. The server 1 is connected to the wireless tag reader 5 via a communication line 9. The server 1 acquires, via a communication line 10, the tag information received by the wireless tag reader 5. Further, the server 1 is connected to the wireless tag issuing apparatus 8 via the communication line 9. The server 1 acquires, via the communication line 9, the unique information and the customer code transmitted by the wireless tag issuing apparatus 8.

One or more POS (Point of Sales) terminals 3 are installed in the payment area 204. Each of the POS terminals executes product registration processing and payment processing on the product to be purchased by the customer. The POS terminal 3 performs payment processing on the product on which the product registration processing has been performed, and transmits the product information (product name, product price, etc.) and the payment information (total amount, deposit amount, change information, etc.) to the server 1. The server 1 is connected to the POS terminal 3 via the communication line 9. The server 1 acquires, via the communication line 9, the product information and the payment information from the POS terminal 3, and accumulates and stores them as sales information.

Further, the display 7 such as a signage is installed in the vicinity of the entrance 201 of the store 200. The display 7 is connected to the server 1 via the communication line 9. The display 7 displays information indicating a density of crowd in the store 200 to customers entering the store 200.

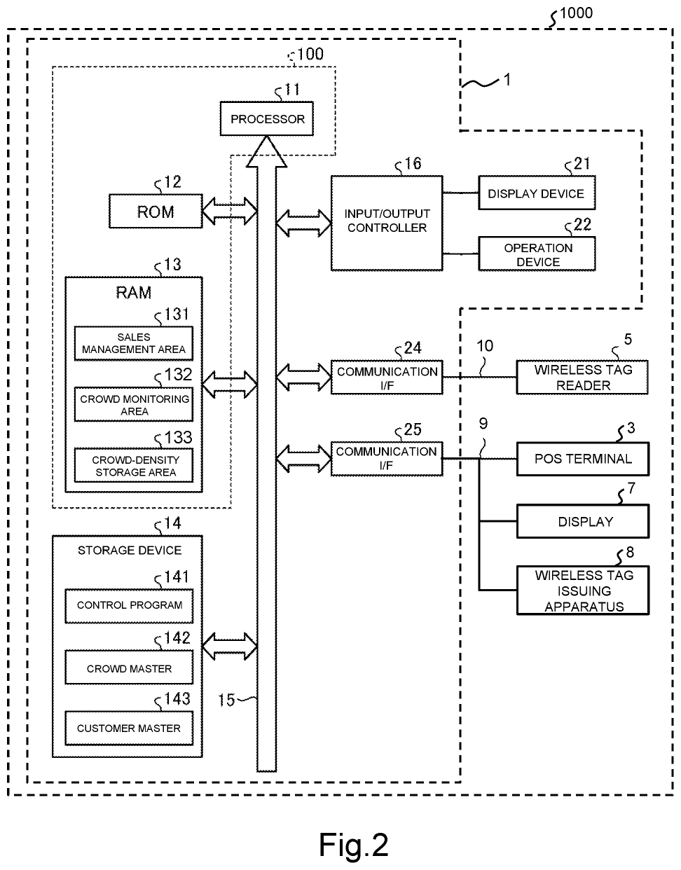

Now, the hardware configuration of the server 1 included in the information processing system 1000 is described. FIG. 2 is a block diagram showing a hardware configuration of the server 1. As shown in FIG. 2, the server 1 includes a controller 100, a storage device 14, and the like. The controller 100 includes a processor 11 and memories 12 and 13. The processor 11 is, for example, a central processing unit (CPU). The memories 12 and 13 are, for example, a ROM (Read Only Memory) 12 and a RAM (Random Access Memory) 13, respectively. The processor 11 performs control. The ROM 12 stores various programs. The RAM 13 expands programs and various types of data. The storage device 14 stores various programs. The processor 11, the ROM 12, the RAM 13, and the storage device 14 are connected to each other via a bus 15. The processor 11 of the controller 100 operates in accordance with a control program that is stored in the ROM 12 or the storage device 14 and expanded into the RAM 13, thereby executing the control processing of the server 1 described below.

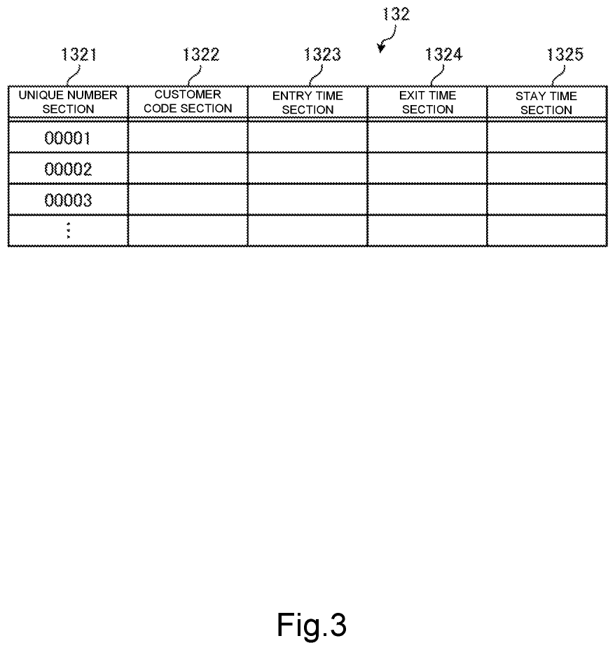

The RAM 13 includes a sales management unit 131, a crowd monitoring unit 132, and a crowd-density storage unit 133. The sales management unit 131 stores the sales information collected from all the POS terminals 3 installed in the store 200. The crowd monitoring unit 132 stores information, data, and the like for determining whether or not the store 200 is crowded with customers and the like. The crowd monitoring unit 132 will be described below (see FIG. 3). The crowd-density storage unit 133 stores a crowd density (congestion degree) indicating a density of crowd in the store 200.

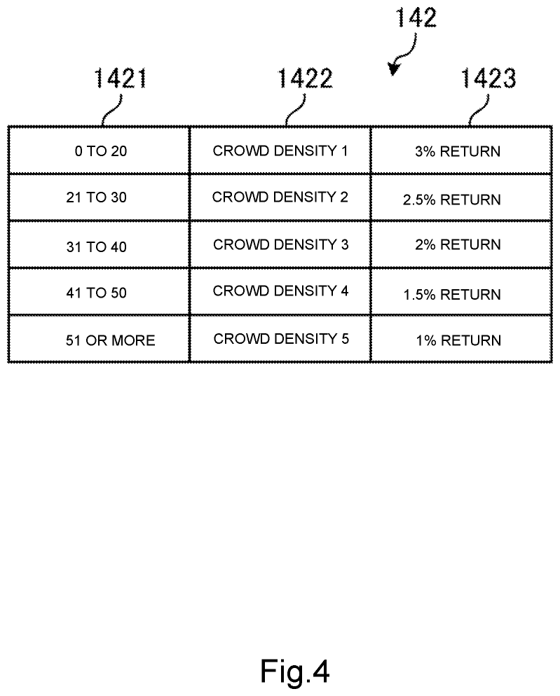

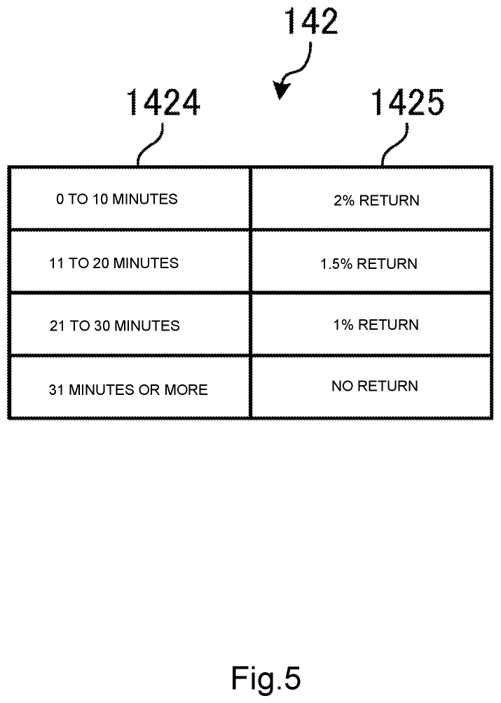

The storage device 14 includes an HDD (Hard Disc Drive), a flash memory, or the like, and maintains the stored content even if a power source is cut off. The storage device 14 includes a control program unit 141, a crowd master file 142 (hereinafter, referred to simply as the crowd master 142), and a customer master file 143 (hereinafter, referred to simply as a customer master 143). The control program unit 141 stores a program for controlling the server 1. The crowd master 142 stores various types of information for determining the crowd density of the store 200. The crowd master 142 will be described below (see FIG. 4 and FIG. 5). The customer master 143 stores, for each customer code, customer information including information regarding points (example of reward) held by the customer.

The controller 100 is connected to a display device 21 and an operation device 22 via the bus 15 and an input/output controller 16. The display device 21 displays information to an operator who operates the server 1. The operation device 22 is, for example, a keyboard.

Further, the controller 100 is connected to a communication interface (I/F) 24 via the bus 15. The communication interface 24 is connected via the communication line 10 to the wireless tag reader 5 installed in the store 200. Further, the controller 100 is connected to a communication interface (I/F) 25 via the bus 15. The communication interface 25 is connected to the wireless tag issuing apparatus 8, the POS terminal 3, and the display 7 via the communication line 9.

Next, the crowd monitoring unit 132 of the RAM 13 will be described. FIG. 3 is a memory map showing the crowd monitoring unit 132. The crowd monitoring unit 132 includes a unique number section 1321, a customer code section 1322, an entry time section 1323, an exit time section 1324, and a stay time section 1325. The unique number section 1321 stores a unique number for uniquely specifying the wireless tag issued automatically by the wireless tag issuing apparatus 8 so as to be distinguishable from other wireless tags. The customer code section 1322 stores the customer code for specifying the customer, which has been read by the wireless tag issuing apparatus 8, in association with the unique number stored in the unique number section 1321. The entry time section 1323 stores the time at which the wireless tag reader 51 received the tag information (entry time), which has been acquired from the wireless tag reader 51, in association with the received unique number. In the case where the tag information is not received from the wireless tag reader 51, the entry time section 1323 stores the time at which a different wireless tag reader 5 received the tag information, which has been acquired from the different wireless tag reader 5, as the entry time in association with the received unique number. The exit time section 1324 stores the time at which the wireless tag reader 52 received the tag information (exit time), which has been acquired from the wireless tag reader 52, in association with the received unique number. The stay time section 1325 stores the time period in which the wireless tag of the unique number (i.e., the customer carrying the wireless tag) stays in the store 200, which has been calculated on the basis of the entry time stored in the entry time section 1323 and the exit time stored in the exit time section 1324.

Next, the crowd master 142 of the storage device 14 will be described. FIG. 4 and FIG. 5 are each a memory map showing the crowd master 142. FIG. 4 shows the relationship between the number of customers in the store 200 and the crowd density of the store 200. Further, FIG. 4 shows points to be returned to the customer in accordance with the crowd density. In FIG. 4, the crowd master 142 includes a number-of-people section 1421, a crowd-density section 1422, and a point return section 1423.

The number-of-people section 1421 divides and stores the range of the number of customers staying in the store 200. Note that the number of customers staying in the store 200 is an average value of the number of different unique numbers obtained from pieces of tag information received by the wireless tag reader 51 or the wireless tag reader 5 (except for the wireless tag reader 52) for a predetermined period of time (e.g., 10 minutes). In other words, the number of unique numbers is the number of wireless tags in the store 200, i.e., the number of customers in the store 200. The number of persons (the above-mentioned average value) stored in the number-of-people section 1421 is divided into ranges of, for example, 0 to 20, 21 to 30, 31 to 40, 41 to 50, and 51 or more.

The crowd-density section 1422 stores the crowd density of the store 200 according to the number of people. The crowd-density section 1422 stores a crowd density corresponding to the number of persons stored in the number-of-persons unit 1421. The crowd-density section 1422 stores a crowd density 1 corresponding to, for example, 0 to 20 customers staying in the store 200. Further, the crowd-density section 1422 stores a crowd density 2 corresponding to 21 to 30 customers. Further, the crowd-density section 1422 stores a crowd density 3 corresponding to 31 to 40 customers. Further, the crowd-density section 1422 stores a crowd density 4 corresponding to 41 to 50 customers. Further, the crowd-density section 1422 stores a crowd density 5 corresponding to 51 or more customers. Regarding the crowd density, the crowd density 1 indicates that the store 200 is empty (has the smallest crowd density), the crowd density increases in the order of the crowd densitys 2, 3, and 4, and the crowd density 5 indicates that the store 200 is the most crowded (has the largest crowd density).

The point return section 1423 stores a point (reward) return rate to be granted to the customer in accordance with the crowd density of the store 200. The point return section 1423 stores a larger point return rate as the crowd density of the store 200 is smaller, and stores a smaller point return rate as the crowd density of the store 200 is larger. For example, a point return rate for returning 3% of the purchase amount in the store 200 as points corresponding to the crowd density 1, which indicates that the store 200 is the most vacant, is stored. Further, a point return rate for returning 2.5% of the purchase amount as points corresponding to the crowd density 2 is stored. Further, a point return rate for returning 2% of the purchase amount as points corresponding to the crowd density 3 is stored. Further, a point return rate for returning 1.5% of the purchase amount as points corresponding to the crowd density 4 is stored. Further, a point return rate for returning 1% of the purchase amount as points corresponding to the crowd density 5 is stored.

In FIG. 5, the crowd master 142 includes a stay-time-period section 1424 and a point return section 1425. The stay-time-period section 1424 shows the range of the stay time period in which one customer stays in the store 200. The stay time period is divided into ranges of, for example, 0 minute to 10 minutes, 11 minutes to 20 minutes, 21 minutes to 30 minutes, and 31 minutes or more.

The point return section 1425 stores a point (reward) return rate to be granted to the customer in accordance with the stay time period of the customer in the store 200. The point return section 1425 stores a larger point return rate as the stay time period in the store 200 is shorter, and stores a smaller point return rate as the stay time period in the store 200 is longer. For example, in the case where the range of the stay time period is 0 to 10 minutes, a point return rate for returning 2% of the purchase amount as points is stored. Further, in the case where the range of the stay time period is 11 to 20 minutes, a point return rate for returning 1.5% of the purchase amount as points is stored. Further, in the case where the range of the stay time period is 21 to 30 minutes, a point return rate for returning 1% of the purchase amount as points is stored. Further, in the case where the range of the stay time period is 31 minutes or more, no point is returned.

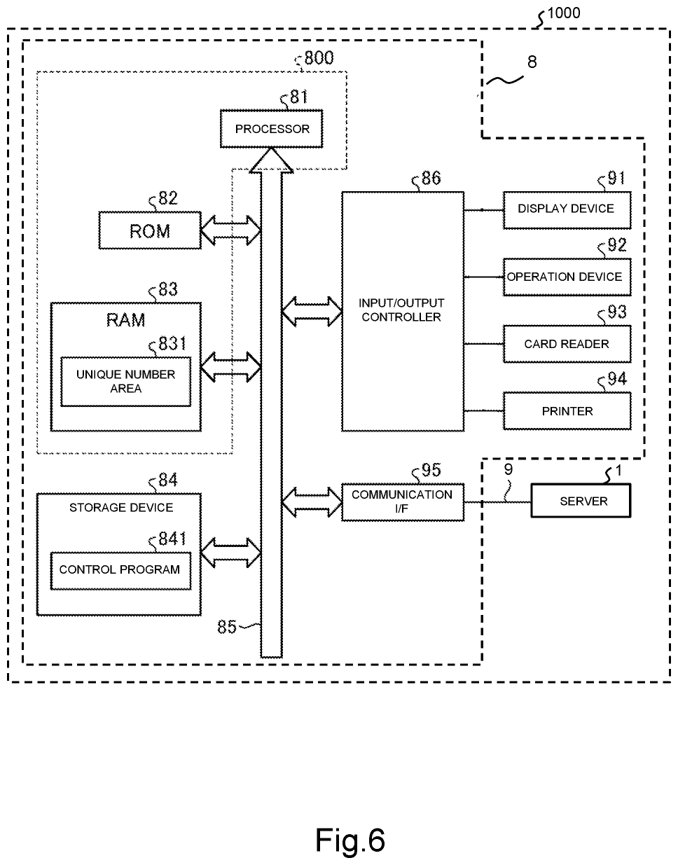

The hardware configuration of the wireless tag issuing apparatus 8 included in the information processing system 1000 will be described below. FIG. 6 is a block diagram showing a hardware configuration of the wireless tag issuing apparatus 8. As shown in FIG. 6, the wireless tag issuing apparatus 8 includes a controller 800, a storage device 84, a CPU 81, a ROM 82, a RAM 83, a memory unit 84, and the like. The controller 800 includes a processor 81 and memories 82 and 83. The processor 81 is, for example, a CPU. The memories 82 and 83 are, for example, the ROM 82 and the RAM 83, respectively. The processor 81 performs control. The ROM 82 stores various programs. The RAM 83 expands programs and various types of data. The storage device 84 stores various programs. The processor 81, the ROM 82, the RAM 83, and the storage device 84 are connected to each other via a bus 85. The processor 81 of the controller 800 operates in accordance with a control program that is stored in the ROM 82 or the storage device 84 and expanded into the RAM 83, thereby executing the control processing of the wireless tag issuing apparatus 8 described below.

The RAM 83 includes a unique number management unit 831. The unique number management unit 831 stores a unique number to be written to the wireless tag issued from the wireless tag issuing apparatus 8. The processor 81 of the controller 800 generates a unique number obtained by adding one to the unique number stored in the unique number management unit 831 and writes the generated unique number to the wireless tag.

The storage device 84 includes an HDD, a flash memory, or the like, and maintains the stored content even if a power source is cut off. The storage device 84 includes a control program unit 841. The control program unit 841 stores a program for controlling the wireless tag issuing apparatus 8.

The controller 800 is connected to a display device 91, an operation device 92, a card reader 93, and a printer 94 via the bus 85 and a controller 86. The display device 91 displays information to an operator who operates the wireless tag issuing apparatus 8. The operation device 92 is, for example, a keyboard. The card reader 93 electrically or magnetically reads at least a customer code for specifying a customer from a customer card held by the customer. The printer 94 performs printing on the surface of the wireless tag issued by the wireless tag issuing apparatus 8. The printer 94 prints, on the surface of the wireless tag, information (e.g., a reference number) by which, for example, the wireless tag can be used as a numbered ticket. The person in charge of the store 200 limits the entry to the store 200 or checks whether or not a customer can enter the store, on the basis of the reference number printed on the wireless tag.

Further, the controller 800 is connected to a communication interface (I/F) 95 via the bus 85. The communication interface 95 is connected to the server 1 via the communication line 9.

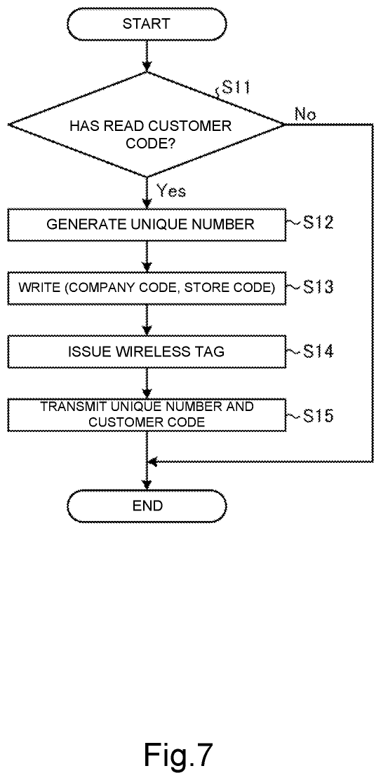

The control of the wireless tag issuing apparatus 8 will be described below. FIG. 7 is a flowchart showing a part of the flow of the control processing of the wireless tag issuing apparatus 8. As shown in FIG. 7, in Step S11, the processor 81 of the controller 800 of the wireless tag issuing apparatus 8 determines whether or not the card reader 93 has read the customer code from the customer card. In the case where it is determined that the customer code has been read from the customer card (Yes in Step S11), the processing of the processor 81 proceeds to Step S12. In Step S12, the processor 81 generates a unique number obtained by adding one to the unique number stored in the unique number management unit 831 of the RAM 83. Next, in Step S13, the processor 81 writes the company code, the store code, and the generated unique number (see Step S12) to the wireless tag. In Step S14, the processor 81 prints, by the printer 94, information of a numbered ticket, for example, on the wireless tag to which the company code, the store code, and the unique number have been written, and issues the wireless tag to the customer. Note that in the wireless tag issuing apparatus 8, in the case where a sensor (not shown) detects a person who intends to enter the store 200 from the entrance 201, the processor 81 of the controller 800 may automatically issue the wireless tag. Alternatively, the wireless tag issuing apparatus 8 may include a wireless tag issuing button, and issue the wireless tag in the case where the issuing button is operated by the customer.

Next, in Step S15, the processor 81 transmits, to the server 1, the unique number written to the wireless tag and the customer code read from the customer card (see Step S11) in association with each other. The processing of the processor 81 of the controller 800 shown in FIG. 7 ends. Further, in the case where it is determined in Step S11 that the customer code has not been read by the card reader 93 (No in Step S11), the processing of the processor 81 shown in FIG. 7 ends. Note that the processor 81 repeats the processing from Step S11 after the processing shown in FIG. 7 ends.

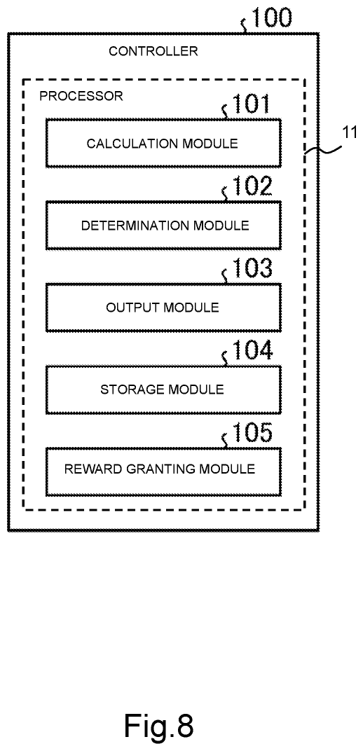

The functional configuration of the server 1 will be described below. FIG. 8 is a functional block diagram showing a functional configuration of the server 1. The processor 11 of the controller 100 functions as a calculation module 101, a determination module 102, an output module 103, a storage module 104, and a reward granting module 105 in accordance with a control program that is stored in the ROM 12 or the storage device 14 and expanded into the RAM 13.

The calculation module 101 calculates the number of wireless tags in the store 200 on the basis of the number of unique numbers of the wireless tags received from the wireless tag issuing apparatus 8 connected to the server 1 or received by one or more wireless tag readers 5 connected to the server 1. Specifically, the unique number of the wireless tag received from the wireless tag issuing apparatus 8 or the unique number received by the wireless tag reader 51 (or the wireless tag reader 5) is stored in the crowd monitoring unit 132 of the RAM 13 described above. The calculation module 101 calculates the number of unique numbers stored in the crowd monitoring unit 132. Note that the unique number is unique information for specifying the wireless tag carried by the customer staying in the store 200. Therefore, the calculated number of unique numbers described above is the number of wireless tags in the store 200. That is, the calculation module 101 calculates the number of wireless tags in the store 200 on the basis of the number of received unique numbers indicating different wireless tags. More specifically, the calculation module 101 calculates, as the number of wireless tags, an average value of the number of wireless tags in the store 200 for a predetermined period of time (e.g., 10 minutes).

The determination module 102 determines the crowd density of the store 200 on the basis of the calculated number of wireless tags. Specifically, the determination module 102 searches the crowd master 142 of the storage device 14, and uses the number of wireless tags calculated by the calculation module 101 as the number of customers staying in the store 200 to acquire the crowd density including the number from the crowd-density section 1422 of the crowd master 142. The determination module 102 determines the crowd density of the store 200 on the basis of the acquired crowd density.

The output module 103 outputs information indicating the crowd density of the store 200 determined by the determination module 102 to the display 7 so as to be displayable. Specifically, the output module 103 outputs information (e.g., one star mark for the crowd density 1 and five star marks for the crowd density 5) obtained by converting the crowd density of the store 200 determined by the determination module 102 so as to be visually understandable to the display 7 as information that can be displayed by the display 7.

The storage module 104 stores the unique number received by the wireless tag reader 5 except for the wireless tag reader 52 in the crowd monitoring unit 132 of the RAM 13. Further, the unique number received by the specific wireless tag reader 52 of the wireless tag readers 5 is deleted from the crowd monitoring unit 132. Specifically, the storage module 104 newly stores, of the unique numbers received from the wireless tag reader 5 (including the wireless tag reader 51) except for the wireless tag reader 52, the unique number that has not been stored in the unique number section 1321 of the crowd monitoring unit 132. Further, the storage module 104 deletes the unique number received by the wireless tag reader 52, which is the specific wireless tag reader 5, from the crowd monitoring unit 132.

The calculation module 101 calculates the number of unique numbers stored in the crowd monitoring unit 132 of the RAM 13. That is, the calculation module 101 calculates the number of wireless tags in the store 200.

The reward granting module 105 grants points according to the crowd density determined by the determination module 102 to the customer. Specifically, in the case where the crowd density determined by the determination module 102 is low, the reward granting module 105 grants points at a high return rate stored in the crowd master 142 of the storage device 14 in association with the low crowd density. In the case where the crowd density determined by the determination module 102 is high, the reward granting module 105 grants points at a low return rate stored in the crowd master 142 in association with the high crowd density.

The storage module 104 stores the time at which the wireless tag reader 5 (including the wireless tag reader 51) except for the wireless tag reader 52 received the unique number for the first time in the crowd monitoring unit 132 of the RAM 13, as the entry time of the customer carrying the wireless tag having the unique number. Further, the storage module 104 stores the time relating to the unique number received by the wireless tag reader 52 in the crowd monitoring unit 132 of the RAM 13, as the exit time of the customer carrying the wireless tag having the unique number.

The calculation module 101 calculates, on the basis of the stored entry time and exit time, the stay time period of the customer carrying the wireless tag indicated by the unique number in the store 200. The reward granting module 105 grants points on the basis of the number of wireless tags and the stay time period calculated by the calculation module 101.

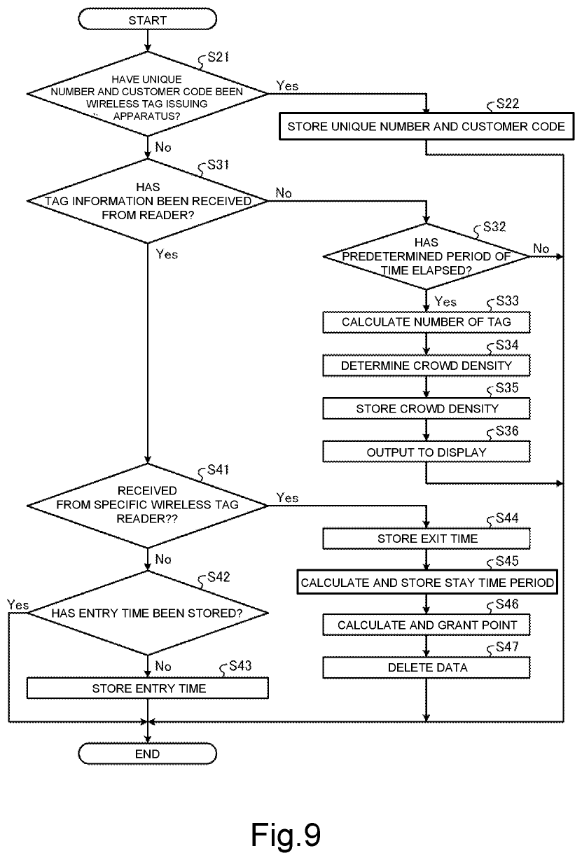

The control of the server 1 will be described below. FIG. 9 is a flowchart showing the flow of the control processing of the server 1. As shown in FIG. 9, in Step S21, the processor 11 of the controller 100 determines whether or not the unique number and the customer code (see Step S15 shown in FIG. 7) have been received from the wireless tag issuing apparatus 8. In the case where it is determined that the unique number and the customer code have been received (Yes in Step S21), the processing of the processor 11 proceeds to Step S22. In Step S22, the storage module 104 of the processor 11 stores the received unique number in the unique number section 1321 (see FIG. 3) of the crowd monitoring unit 132 and stores the customer code in the customer code section 1322 (see FIG. 3) in association with the unique number stored in the unique number section 1321. Then, the processing of the processor 11 of the controller 100 ends.

Further, in the case where it is determined in Step S21 that the unique number and the customer code from the wireless tag issuing apparatus 8 have not been received (No in Step S21), the processing of the processor 11 proceeds to Step S31. In Step S31, the processor 11 of the controller 100 determines whether or not the tag information and the time have been received from the wireless tag reader 5. In the case where it is determined that the tag information has not been received (No in Step S31), the processing of the processor 11 proceeds to Step S32. In Step S32, whether or not a predetermined period of time (e.g., 10 minutes) has elapsed since the crowd density has been previously determined is determined. In the case where it is determined that the predetermined period of time has elapsed (Yes in Step S32), the processing of the processor 11 proceeds to Step S33. In Step S33, the calculation module 101 of the processor 11 calculates the number of wireless tags in the store 200 on the basis of the number of unique numbers (see Step S22) stored in the unique number section 1321 of the crowd monitoring unit 132. In Step S34, the determination module 102 of the processor 11 refers to the crowd master 142 of the storage device 14 on the basis of the number of unique numbers calculated by the calculation module 101. The determination module 102 determines, on the basis of which range of the number-of-people section 1421 of the crowd master 142 the number of unique numbers stored in the unique number section 1321 is included, the crowd density of the store 200 corresponding to the number of unique numbers. For example, the determination module 102 of the processor 11 determines, in the case where the number of unique numbers stored in the unique number section 1321 is 25, that the crowd density is the crowd density 2 because the number of unique numbers is included in the range of 21 to 30. In Step S35, the processor 11 of the controller 100 stores the determined crowd density in the crowd-density storage unit 133. In Step S36, the output module 103 of the processor 11 transmits (outputs), to the display 7, crowd information (e.g., the number of stars corresponding to the crowd density) corresponding to the crowd density stored in the crowd-density storage unit 133 of the RAM 13. Then, the processing of the processor 11 of the controller 100 ends. Note that in the case where it is determined in Step S32 that the predetermined period of time has not elapsed (No in Step S32), the processing of the processor 11 ends.

The display 7 that has received the crowd information displays information (e.g., the number of stars) indicating the crowd density of the store 200, which corresponds to the received crowd information. The customer can check the present crowded situation in the store 200 in real time by viewing information indicating the crowd density of the store 200 displayed on the display 7.

Further, in the case where it is determined in Step S31 that the tag information has been received from the wireless tag reader 5 (Yes in Step S31), the processing of the processor 11 proceeds to Step S41. In Step S41, the processor 11 determines whether or not the wireless tag reader that has received the tag information and the time is the wireless tag reader 52 (specific wireless tag reader). In the case where it is determined that the wireless tag reader that has received the tag information is not the wireless tag reader 52 (No in Step S41), the processing of the processor 11 proceeds to Step S42. In Step S42, the processor 11 searches the crowd monitoring unit 132 of the RAM 13 on the basis of the unique number included in the tag information. The processor 11 determines whether or not the entry time corresponding to the unique number has been stored in the entry time section 1323 of the RAM 13. In the case where it is determined that the entry time has not been stored (No in Step S42), the processing of the processor 11 proceeds to Step S43. In Step S43, the processor 11 stores the received time in the entry time section 1323 as the entry time. Then, the processing of the processor 11 ends. Further, in the case where it is determined in Step S42 that the entry time has been stored (Yes in Step S42), the processing of the processor 11 ends.

Further, in the case where it is determined in Step S41 that the tag information and the time have been received from the wireless tag reader 52 (Yes in Step S41), the processing of the processor 11 proceeds to Step S44. In Step S44, the processor 11 stores the received time in the exit time section 1324. In Step S45, the processor 11 calculates, on the basis of the entry time (see Step S43) stored in the entry time section 1323 of the RAM 13 and the exit time (see Step S44) stored in the exit time section 1324, the stay time period of the wireless tag that has transmitted the received tag information in the store 200 (i.e., the stay time period of the customer carrying the wireless tag in the store 200). Then, the processor 11 stores the calculated stay time period in the stay time section 1325 of the RAM 13.

Next, in Step S46, the reward granting module 105 of the processor 11 refers to the crowd master 142 of the storage device 14 on the basis of the stored crowd density (see Step S35). The reward granting module 105 of the processor 11 then acquires the return rate (see FIG. 4) associated with the crowd density from the point return section 1423 of the crowd master 142. Further, the reward granting module 105 of the processor 11 refers to the crowd master 142 of the storage device 14 on the basis of the calculated stay time period (see Step S45). The reward granting module 105 of the processor 11 acquires the return rate (see FIG. 5) associated with the stay time period from the point return section 1425 of the crowd master 142. The reward granting module 105 of the processor 11 calculates points corresponding to the purchase amount of the product at a return rate obtained by adding the return rate associated with the crowd density and the return rate associated with the stay time period. The reward granting module 105 of the processor 11 then grants the calculated points to the customer specified by the customer code. Specifically, the reward granting module 105 of the processor 11 adds the points calculated by applying the return rate to the purchase amount of the customer to the points of the customer stored in the customer master 143, thereby granting the points to the customer. In Step S47, the processor 11 deletes all pieces of data corresponding to the unique number, which have been stored in the crowd monitoring unit 132. Then, the processing of the processor 11 ends. Note that the processor 11 repeats the processing from Step S21 after the processing shown in FIG. 9 ends. Further, the wireless tag issued from the wireless tag issuing apparatus 8 is collected when a payment is made by the POS terminal 3. The customer who has completed the payment leaves the store 200 through the exit 205.

As described above, in accordance with the embodiment, in the server 1, the processor 11 of the controller 100 functions as the calculation module 101, the determination module 102, and the output module 103. The calculation module 101 is connected to one or more wireless tag readers 5 and calculates the number of wireless tags in the store 200 on the basis of the number of unique numbers for identifying the wireless tags carried by the customers staying in the store 200, which have been received by the wireless tag reader 5. The determination module 102 determines the crowd density of the store 200 on the basis of the number of wireless tags calculated by the calculation module 101. The output module 103 outputs information indicating the crowd density of the store 200 determined by the determination module 102 to the display 7 so as to be displayable.

In such a server 1, information indicating the determined crowd density of the store 200 is output to the display 7 so as to be displayable. Therefore, it is possible for the customer to properly grasp the crowded situation of the store 200. Further, since the crowd density of the store 200 is determined using the unique number of the wireless tag, the crowd density of the entire store 200 can be accurately determined with a simpler structure of imaging the inside of the store 200 with a camera and determining the crowd density of the store 200 on the basis of the number of imaged people.

Further, in the embodiment, as information indicating the crowd density of the store 200, information by which the crowd density of the store 200 can be visually recognized, e.g., information for changing the number of stars in accordance with the crowd density, is output. However, the embodiment is not limited thereto, and display other than the number of stars may be displayed on the display 7. Further, for example, information for displaying the present return rate at the same time may be output.

Further, in the embodiment, the wireless tag reader 51 and a plurality of wireless tag readers 5 are used. However, the embodiment is not limited thereto, and only the wireless tag reader 51 and the wireless tag reader 52 may be used.

Further, in the embodiment, in the processor 11, the reward granting module 105 grants points on the basis of the number of wireless tags and the stay time period calculated by the calculation module 101. However, the embodiment is not limited thereto, and the reward granting module 105 may grant points on the basis of only the number of wireless tags calculated by the calculation module 101. In this case, the stay time period of the customer is not a target for granting points.

Note that the program executed by the server 1 according to the embodiment is recorded on a computer-readable recording medium such as a CD-ROM, a flexible disk (FD), a CD-R, and a DVD (Digital Versatile Disc) as a file of an installable format or an executable format and provided.

Further, the program executed by the server 1 according to the embodiment may be stored in a computer connected to a network such as the Internet, and may be provided by being downloaded through the network. Further, the program executed by the server 1 according to the embodiment may be provided or distributed through a network such as the Internet.

Further, the program executed by the server 1 according to the embodiment may be incorporated in the ROM 12 or the like in advance and provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus that manages sales of products in a store in which a wireless tag to which unique information is written is issued to a customer entering the store, the customer carrying the wireless tag to enter the store, comprising:
a first communication interface that communicates with a wireless tag reader that receives the unique information from the wireless tag carried by the customer in the store;
a second communication interface that communicates with a display that displays information regarding a crowd density indicating a density of crowd in the store;
a storage device that holds a master file for storing in advance the crowd density of the store in accordance with the number of customers in the store; and
a processor that
acquires, via the first communication interface, the unique information received by the wireless tag reader from the wireless tag carried by the customer,
calculates, on a basis of the number of pieces of acquired unique information of the wireless tags, the number of the wireless tags in the store as the number of customers in the store,
searches the master file on a basis of the calculated number of customers in the store, and acquires the crowd density from the master file to determine the crowd density of the store, and
outputs information regarding the crowd density acquired in the determination to the display via the second communication interface so as to be displayable on the display.

2. The information processing apparatus according to claim 1, further comprising
a memory that stores the unique information of the wireless tag received by the wireless tag reader, wherein
the first communication interface communicates with a plurality of wireless tag readers including a specific wireless tag reader installed in a predetermined area in the store, and
the processor
stores, where the unique information of the wireless tag is received by a wireless tag reader other than the specific wireless tag reader, the unique information acquired via the first communication interface in the memory,
deletes, where the unique information of the wireless tag is received by the specific wireless tag reader, the unique information acquired via the first communication interface from the memory, and
calculates, on a basis of the number of pieces of unique information of the wireless tags stored in the memory, the number of the wireless tags in the store as the number of customers in the store.

3. The information processing apparatus according to claim 2, wherein
the master file of the storage device further stores a reward to be granted to the customer in association with the information regarding the crowd density, and
the processor grants a reward corresponding to the crowd density acquired in the determination to the customer making a payment for a purchase amount of products in the store.

4. The information processing apparatus according to claim 3, wherein
the master file of the storage device stores a higher reward as the crowd density is lower, in association with the crowd density.

5. The information processing apparatus according to claim 3, wherein
the memory further stores, in association with the unique information of the wireless tag, a stay time period of the customer carrying the wireless tag in the store,
the storage device further stores, in accordance with the stay time period, the reward to be granted to the customer, and
the processor further grants the reward stored in the storage device in association with the stay time period stored in the memory to the customer making a payment for a purchase amount of products in the store.

6. The information processing apparatus according to claim 5, wherein
the processor
determines a time at which the unique information was received for the first time by the wireless tag reader other than the specific wireless tag reader as an entry time of the customer carrying the wireless tag to which the unique information is written,
determines a time at which the unique information was received by the specific wireless tag reader as an exit time of the customer carrying the wireless tag to which the unique information is written, and
calculates, on a basis of the entry time and the exit time, a stay time period of the customer carrying the wireless tag to which the unique information is written in the store and stores the calculated stay time period in the memory.

7. The information processing apparatus according to claim 5, wherein
the storage device stores a higher reward as the stay time period in the store is shorter, in association with the stay time period.

8. The information processing apparatus according to claim 2, wherein
the first communication interface communicates with a wireless tag reader installed in a payment area of a purchase amount of products in the store as the specific wireless tag reader, and
the processor acquires, via the first communication interface, the unique information of the wireless tag received by the specific wireless tag reader as the unique number of the wireless tag carried by the customer making a payment for a purchase amount of products in the store.

9. An information processing method for an information processing apparatus that manages sales of products in a store in which a wireless tag to which unique information is written is issued to a customer entering the store, the customer carrying the wireless tag to enter the store, comprising:
holding a master file for storing in advance a crowd density indicating a density of crowd in the store in accordance with the number of customers in the store;
acquiring, via a communication interface, the unique information received by a wireless tag reader from the wireless tag carried by the customer;
calculating, on a basis of the number of pieces of acquired unique information of the wireless tags, the number of the wireless tags in the store as the number of customers in the store;
searching the master file on a basis of the calculated number of customers in the store, and acquiring the crowd density from the master file to determine the crowd density of the store; and
outputting information regarding the crowd density acquired in the determination to a display via the communication interface so as to be displayable on the display.

10. An information processing system that manages a store by processing information of the store, comprising:
a wireless tag issuing apparatus that issues a wireless tag to which unique information is written to a customer entering the store;
a display that displays, to the customer, information regarding a crowd density indicating a density of crowd in the store;
a terminal apparatus for registering a product to be purchased by the customer and making a payment for the product;
a wireless tag reader that receives, from the wireless tag that is issued by the wireless tag issuing apparatus and carried by the customer in the store, the unique information of the wireless tag; and
an information processing apparatus that receives, from the terminal apparatus, product-registration information and product-payment information, and performs information processing for managing sales of products in the store, wherein
the information processing apparatus includes
a first communication interface that communicates with the wireless tag,
a second communication interface that communicates with the display, the terminal apparatus, and the wireless tag issuing apparatus,
a storage device that holds a master file for storing in advance the crowd density of the store in accordance with the number of customers in the store, and
a processor that
acquires, via the first communication interface, the unique information received by the wireless tag reader from the wireless tag carried by the customer,
calculates, on a basis of the number of pieces of acquired unique information of the wireless tags, the number of the wireless tags in the store as the number of customers in the store,
searches the master file on a basis of the calculated number of customers in the store, and acquires the crowd density from the master file to determine the crowd density of the store, and
outputs information regarding the crowd density acquired in the determination to the display via the second communication interface so as to be displayable on the display.
